(19) United States
(12) Patent Application Publication
(10) Pub. No.: US 2018/0033378 A1
(43) Pub. Date: Feb. 1, 2018

(54) METHOD AND DEVICE FOR ADJUSTING REFRESH RATE

(71) Applicant: Beijing Xiaomi Mobile Software Co., Ltd., Beijing (CN)

(72) Inventors: Guosheng LI, Beijing (CN); Xiaoxing YANG, Beijing (CN); Lin DAI, Beijing (CN)

(73) Assignee: Beijing Xiaomi Mobile Software Co., Ltd.

(21) Appl. No.: 15/662,994

(22) Filed: Jul. 28, 2017

(30) Foreign Application Priority Data
Jul. 29, 2016 (CN) 201610619168.X

(51) Int. Cl. G09G 3/34

(52) U.S. Cl. CPC G09G 3/34; G09G 2340/0435; G09G 2320/106; G09G 2360/145

(57) ABSTRACT

The present disclosure provides a method for adjusting a refresh rate for a screen of a device. The method includes: detecting whether an image currently displayed on the screen is a static image, the static image being an image that remains unchanged for a predetermined period of time; obtaining a backlight intensity of the screen when the image currently displayed on the screen is the static image; and reducing a current first refresh rate of the screen to a second refresh rate based on the backlight intensity, the second refresh rate being lower than a third refresh rate obtained based on a dynamic frame rate technology.

### CROSS-REFERENCE TO RELATED APPLICATION

This application is based on and claims priority to Chinese Patent Application No. 201610619168.X, filed on Jul. 29, 2016, which is incorporated herein by reference in its entirety.

### FIELD

The present disclosure generally relates to the technical field of computer, and more particularly, to a method and a device for adjusting a refresh rate.

### BACKGROUND

People may enrich their spare time using various applications on a terminal, for example, watching a video with a player, reading a book with an electronic reader, and the like. The screen of the terminal is generally required to have a higher refresh rate for playing videos but not for reading books, so the terminal may need to adjust the refresh rate of its screen. For example, the terminal may retrieve a preset first refresh rate and reduce a current second refresh rate to the preset first refresh rate.

### SUMMARY

According to a first aspect of the present disclosure, a method for adjusting a refresh rate for a screen of a device is provided. The method includes: detecting whether an image currently displayed on the screen is a static image, the static image being an image that remains unchanged for a predetermined period of time; obtaining a backlight intensity of the screen when the image currently displayed on the screen is the static image; and reducing a current first refresh rate of the screen to a second refresh rate based on the backlight intensity, the second refresh rate being lower than a third refresh rate obtained based on a dynamic frame rate technology.

According to a second aspect of the present disclosure, a device is provided. The device includes: a processor, a screen coupled to the processor, and a memory for storing instructions executable by the processor. The processor is configured to: detect whether an image currently displayed on the screen is a static image, the static image being an image that remains unchanged for a predetermined period of time; obtain a backlight intensity of the screen when the image currently displayed on the screen is the static image; and reduce a current first refresh rate of the screen to a second refresh rate based on the backlight intensity, the second refresh rate being lower than a third refresh rate obtained based on a dynamic frame rate technology.

According to a third aspect of the present disclosure, there is provided a non-transitory computer-readable storage medium having stored therein instructions that, when executed by a processor of a device, cause the device to perform a method for adjusting a refresh rate. The method includes: detecting whether an image currently displayed on a screen of the device is a static image, the static image being an image that remains unchanged for a predetermined period of time; obtaining a backlight intensity of the screen when the image currently displayed on the screen is the static image; and reducing a current first refresh rate of the screen to a second refresh rate based on the backlight intensity, the second refresh rate being lower than a third refresh rate obtained based on a dynamic frame rate technology.

It is to be understood that the above general description and the following detailed description are merely for the purpose of illustration and explanation, and are not intended to limit the scope of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for adjusting a refresh rate according to an exemplary embodiment.

FIG. 2 is a flowchart of a method for adjusting a refresh rate according to another exemplary embodiment.

FIG. 3 is a block diagram of a device for adjusting a refresh rate according to an exemplary embodiment.

FIG. 4 is a block diagram of a device for adjusting a refresh rate according to another exemplary embodiment.

FIG. 5 is a block diagram of a device according to an exemplary embodiment.

### DETAILED DESCRIPTION

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the present disclosure. Instead, they are merely examples of devices and methods consistent with aspects related to the present disclosure as recited in the appended claims.

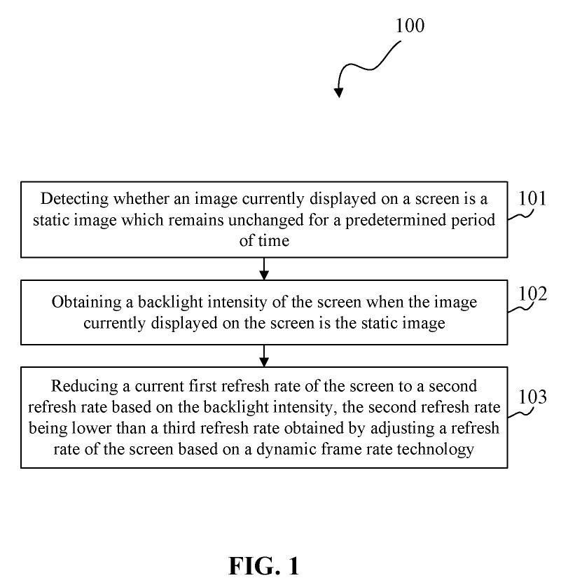

FIG. 1 is a flowchart of a method 100 for adjusting a refresh rate according to an exemplary embodiment. The method 100 may be applied to a terminal. As shown in FIG. 1, the method 100 may include the following steps.

In step 101, it is detected whether an image currently displayed on a screen of the terminal is a static image which remains unchanged for a predetermined period of time.

In step 102, a backlight intensity of the screen is obtained when the image currently displayed on the screen is the static image.

In step 103, a current first refresh rate of the screen is reduced to a second refresh rate based on the backlight intensity, the second refresh rate being lower than a third refresh rate obtained by adjusting a refresh rate of the screen based on a dynamic frame rate technology.

The method 100 provided by the present disclosure may solve problems in the prior art. For example, the screen of the terminal generally has higher power consumption due to a higher refresh rate when the screen displays a static image. With the method 100, the refresh rate of the screen may be reduced according to the dynamic frame rate technology when the screen displays the static image, thereby achieving the effect of saving power consumption. In addition, because the backlight intensity is related with a dimming speed of the screen, the second refresh rate determined based on the backlight intensity may not cause screen flicker, which may solve the problem of screen flicker due to the second refresh rate not suitable for the current backlight intensity of the screen when a same refresh rate is set for the screen with different backlight intensities.

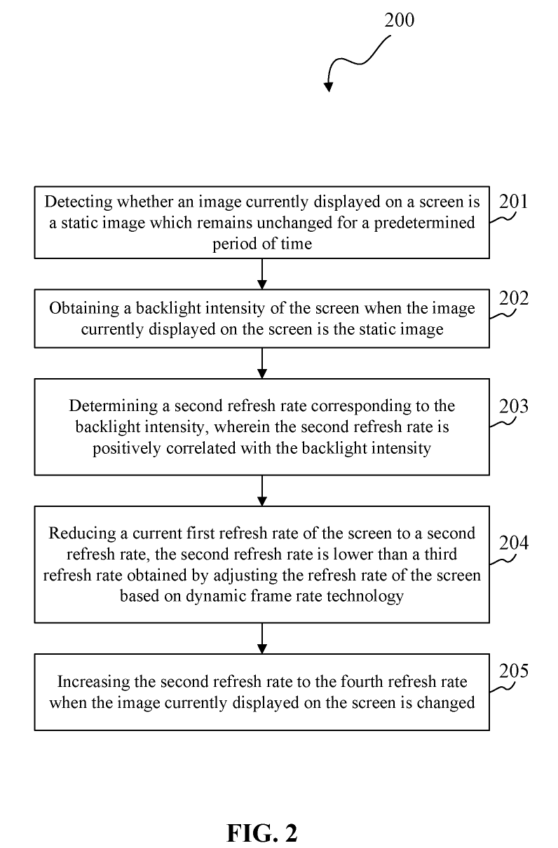

FIG. 2 is a flowchart of a method 200 for adjusting a refresh rate according to another exemplary embodiment. The method 200 may be applied to a terminal. As shown in FIG. 2, the method 200 may include the following steps.

In step 201, it is detected whether an image currently displayed on a screen of the terminal is a static image which remains unchanged for a predetermined period of time.

In the exemplary embodiment, each image displayed on the screen is an image frame and corresponds to one set of valid data. The valid data is cached in a display buffer, and in the exemplary embodiment, the valid data cached in the display buffer is refreshed at a preset refresh rate. For example, the valid data displayed by the screen is periodically refreshed to be a same or different set of valid data. The refresh rate is also known as a frame rate which refers to a frequency of refreshing image frames.

In the exemplary embodiment, the terminal may include one of first and second types of screens. The first type of screen is a video panel which is not configured with a random-access memory (RAM). The second type of screen is a command panel which is configured with a RAM. When the terminal has the first type of screen, an application processor (AP) of the terminal sends the valid data to the screen at a refresh rate, and the screen caches the valid data in the display buffer and displays the valid data. When the AP sends same valid data twice, the screen refreshes the valid data cached in the display buffer to the next same set of valid data. When the terminal has the second type of screen, the AP of the terminal sends the valid data to the screen, and the screen caches the received valid data in the display buffer and displays the valid data. When the valid data has no change, the screen refreshes the valid data cached in the display buffer to the next same set of valid data regularly.

Each image frame displayed on the screen corresponds to a set of valid data. Accordingly, detecting whether the image currently displayed on the screen is a static image may be achieved by detecting whether the valid data received in the predetermined period of time is changed or not. When the valid data received in the predetermined period of time is not changed, it indicates that the valid data received in the predetermined period of time is same, and the valid data displayed after the refresh and the valid data displayed before the refresh are the same. Accordingly, the terminal may reduce the refresh rate of the terminal, so as to save the power consumption for memory access, the power consumption for data transmission, and the power consumption for refresh.

In the exemplary embodiment, the static image may be generated in the following two scenarios. In the first scenario, the terminal is switched from a dynamic scene to a static scene, for example, the screen plays a video at first, and then displays a static image when the user triggers a control key for pausing the video play. In the second scenario, the terminal is in a static situation, for example, the user reads an e-book, browses a webpage and the like, and the image displayed on the screen is a static image.

When reducing the refresh rate of the screen, the terminal may reduce the refresh rate of the screen using the dynamic frame rate technology. For example, the method 200 may further include: determining a first refresh rate corresponding to the static image based on the dynamic frame rate technology when the image currently displayed on the screen is the static image; and reducing a current fourth refresh rate of the screen to the first refresh rate. The fourth refresh rate may be an original refresh rate of the screen, for example, the fourth refresh rate is the refresh rate of factory setting. Also for example, the fourth refresh rate may be 60 Hz.

The dynamic frame rate technology refers to a technology used to reduce a refresh rate of a screen when the screen displays a static image. In general, the dynamic frame rate technology is used to set the same first refresh rate for all screens. If the first refresh rate is set to be too low, the screen may be caused to flicker due to the dimming speed of the screen being positively correlated with a leak current. That is, the more the leak current is, the larger the dimming speed of the screen is; and the less the leak current is, the smaller the dimming speed of the screen. For example, considering a first screen and a second screen, the leak current of the first screen is larger than that of the second screen, and the first and second screens have a same refresh rate and a same brightness after refresh. If the first screen and the second screen refresh a first set of valid data at the same time, and before refreshing the second set of valid data, the brightness of the first screen is smaller than that of the second screen; after refreshing the second set of valid data, the first and second screens have the same brightness, so the brightness change of the first screen before and after refresh is larger than that of the second screen. As a result, the first screen tends to flicker.

A low refresh rate of a screen set based on the dynamic frame rate technology may cause the screen to flicker and, therefore, a relatively high refresh rate is set for the screen based on the dynamic frame rate technology generally. For example, the refresh rate of the terminal may be reduced from 60 Hz to 50 Hz, that is, the terminal changes to display 50 image frames per second from displaying 60 image frames per second.

If the first refresh rate is set to be too high, the terminal may not save the power consumption for memory access, the power consumption for data transmission, and the power consumption for screen refresh to the greatest extent. In the exemplary embodiment, then step 202 may be performed.

In step 202, the backlight intensity of the screen is obtained when the image currently displayed on the screen is the static image.

For example, the backlight intensity is an illumination intensity of backlights in the screen.

In the exemplary embodiment, the illumination of the backlights in the screen may cause electronic migration which may generate an electric current to cause a large leak current of the screen. In other words, the higher the backlight intensity is, the larger the leak current is; and the lower the backlight intensity is, the smaller the leak current is.

In order to avoid the screen flickering before and after refresh, the terminal may need to be set to a higher refresh rate for the screen having a large leak current, and a lower refresh rate for the screen having a small leak current. In other words, the terminal may need to be set to a higher refresh rate for the screen having a higher backlight intensity and a lower refresh rate for the screen having a lower backlight intensity. The backlight intensity is positively correlated with the refresh rate.

In step 203, a second refresh rate corresponding to the backlight intensity is determined, wherein the second refresh rate is positively correlated with the backlight intensity.

In some embodiments, after obtaining the backlight intensity, the terminal may convert the backlight intensity to a backlight current, and then determine the second refresh rate based on the backlight current. In such embodiments, determining the second refresh rate corresponding to the backlight intensity may include: searching a first correspondence for the backlight current corresponding to the backlight intensity, the first correspondence used to record a relationship between different backlight intensities and different backlight currents; and searching a second correspondence for the second refresh rate corresponding to the backlight current, the second correspondence used to record a relationship between different backlight currents and different second refresh rates.

The first correspondence and the second correspondence may be determined based on a preset algorithm, or based on experiments, which is not limited herein.

In one exemplary embodiment, the second correspondence may be as follows: 20 mA-50 Hz; 10 mA-40 Hz; 5 mA-30 Hz; and 2 mA-20 Hz. When implemented, the second refresh rate causes the flicker value less than −30 dB. A flicker value less than −30 dB may ensure the screen not to flicker, so as to ensure the display quality of the image frame.

In step 204, the current first refresh rate of the screen is reduced to the second refresh rate, wherein the second refresh rate is lower than a third refresh rate obtained by adjusting the refresh rate of the screen based on the dynamic frame rate technology.

In the exemplary embodiment, the first refresh rate may be a refresh rate obtained by adjusting the refresh rate of the screen based on the dynamic frame rate technology, e.g., the first refresh rate may be the third refresh rate; or the first refresh rate may be the original refresh rate, i.e., the first refresh rate may be the fourth refresh rate.

In one exemplary embodiment, a first transmission rate is determined based on the second refresh rate and a current second transmission rate is adjusted to the first transmission rate. The first transmission rate is a data transmission rate of the static image and is lower than the second transmission rate, and the second transmission rate corresponds to the first refresh rate.

In the exemplary embodiment, the screen displays a set of valid data after receiving the set of valid data completely, so the refresh rate may be reduced by reducing the data transmission rate. For example, the current refresh rate is 60 Hz which corresponds to a data transmission rate of a Kb/s, and if the matched refresh rate is 30 Hz, then the data transmission rate corresponding to the 30 Hz is a/2 Kb/s.

In one exemplary embodiment, data is transmitted with the current second transmission rate. The data include at least two sets of valid data between which at least one set of invalid data is inserted. The valid data is the data of the static image and the invalid data is not displayed on the screen. The second transmission rate corresponds to the first refresh rate.

In the exemplary embodiment, the screen refreshes the currently displayed valid data with the received valid data, so the invalid data may be inserted between the valid data. When the invalid data is received by the terminal, the terminal may not refresh the currently displayed valid data with the invalid refresh data, so as to reduce the refresh rate.

The number of the inserted invalid data relates to the second refresh rate and the first refresh rate. For example, if the current first refresh rate is 60 Hz, 60 sets of valid data are required to be transmitted in 1 second. If the second refresh rate is 30 Hz, 30 sets of valid data are required to be transmitted in 1 second, and 30 sets of invalid data may be inserted in the 1 second. If the second refresh rate is 50 Hz, 50 sets of valid data are required to be transmitted in 1 second, and 10 sets of invalid data may be inserted in the 1 second.

The terminal may evenly insert the invalid data between the valid data. For example, if 30 sets of valid data and 30 sets of invalid data are required to be transmitted in 1 second, one set of invalid data may be inserted between every two sets of valid data. If 50 sets of valid data and 10 sets of invalid data are required to be transmitted in 1 second, one set of invalid data may be inserted every five sets of valid data. The invalid data may be inserted in other ways, which is not limited herein.

The idle time between transmissions of two sets of valid data is known as porch. Accordingly, a porch value can be increased in the exemplary embodiment.

In step 205, the second refresh rate is increased to the fourth refresh rate when the image currently displayed by the terminal is changed.

For example, when the image currently displayed is changed, the terminal increases the current second refresh rate to the fourth refresh rate for the screen.

When the first refresh rate is the fourth refresh rate, the terminal needs to increase the second refresh rate to the first refresh rate. The process of reducing the second refresh rate to the first refresh rate by the terminal is opposite to the process of increasing the first refresh rate to the second refresh rate by the terminal. For example, the terminal adjusts the first transmission rate to the second transmission rate, or data may be transmitted with the second transmission rate, and the data only includes valid data, which is not limited herein.

When the third refresh rate is the first refresh rate, the terminal needs to increase the second refresh rate to the fourth refresh rate. For example, the terminal adjusts the first transmission rate to a third transmission rate corresponding to the fourth refresh rate, or data may be transmitted with the third transmission rate and the data only include valid data. In this case, the third transmission rate is higher than the second transmission rate.

The method 200 may solve the problem that a screen has a higher power consumption due to a higher refresh rate set according to the dynamic frame rate technology when the screen displays a static image, thereby achieving the effect of saving power consumption. In addition, due to the backlight intensity being related with a dimming speed of the screen, the second refresh rate determined based on the backlight intensity may not cause the screen to flicker, which may solve the problem of screen flicker when a same refresh rate is set for the screen with different backlight intensities.

Further, when the image currently displayed by the terminal is changed, the method 200 further increases the second refresh rate to the fourth refresh rate. As such, the method 200 may further solve the following problem and improve the display effect of the screen: when the second refresh rate is used to display a varying image and the refresh rate is lower than the change rate of the varying image, the screen cannot display the whole image which causes incomplete display of the image.

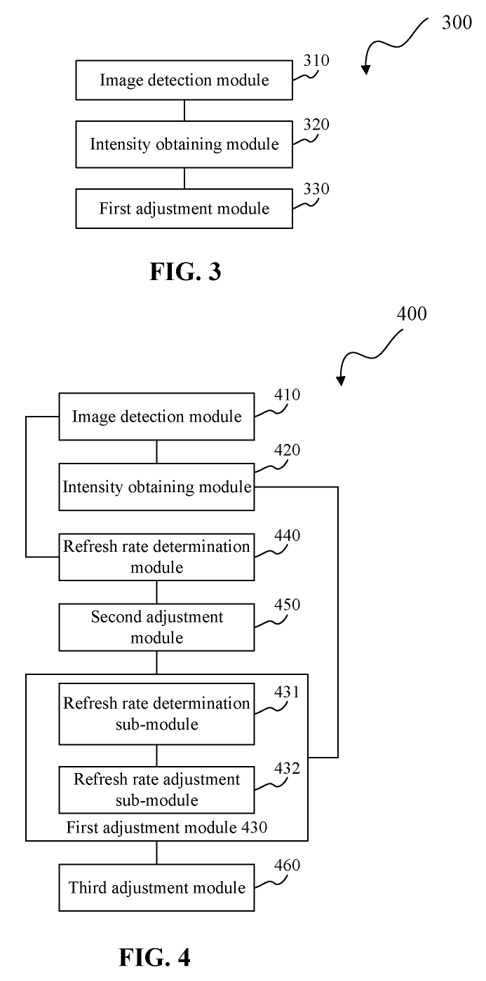

FIG. 3 is a block diagram of a device 300 for adjusting a refresh rate according to an exemplary embodiment. The device 300 may be applied to a terminal. As shown in FIG. 3, the device 300 may include: an image detection module 310, an intensity obtaining module 320, and a first adjustment module 330.

The image detection module 310 is configured to detect whether an image currently displayed on a screen is a static image which remains unchanged for a predetermined period of time.

The intensity obtaining module 320 is configured to obtain a backlight intensity of the screen when the image currently displayed on the screen is the static image.

The first adjustment module 330 is configured to reduce a current first refresh rate of the screen to a second refresh rate based on the backlight intensity. The second refresh rate is lower than a third refresh rate obtained by adjusting the refresh rate of the screen based on a dynamic frame rate technology.

The device 300 may solve the problem that a screen has a higher power consumption due to a higher refresh rate set according to the dynamic frame rate technology when the screen displays a static image, thereby achieving the effect of saving power consumption. In addition, due to the backlight intensity being related with a dimming speed of the screen, the second refresh rate determined based on the backlight intensity may not cause the screen to flicker, which may solve the problem of screen flicker when a same refresh rate is set for the screen with different backlight intensities.

FIG. 4 is a block diagram a device 400 for adjusting a refresh rate according to an exemplary embodiment. The device 400 may be applied to a terminal. As shown in FIG. 4, the device 400 may include: an image detection module 410, an intensity obtaining module 420, and a first adjustment module 430.

The image detection module 410 is configured to detect whether an image currently displayed on a screen is a static image which remains unchanged for a predetermined period of time.

The intensity obtaining module 420 is configured to obtain a backlight intensity of the screen when a detection result of the image detection module 410 is that the image currently displayed on the screen is the static image.

The first adjustment module 430 is configured to reduce a current first refresh rate of the screen to a second refresh rate based on the backlight intensity obtained by the intensity obtaining module 420. The second refresh rate is lower than a third refresh rate obtained by adjusting the refresh rate of the screen based on a dynamic frame rate technology.

In one exemplary embodiment, the first adjustment module 430 includes: a refresh rate determination sub-module 431 and a refresh rate adjustment sub-module 432.

The refresh rate determination sub-module 431 is configured to determine the second refresh rate corresponding to the backlight intensity, wherein the second refresh rate is positively correlated with the backlight intensity.

The refresh rate adjustment sub-module 432 is configured to reduce the current first refresh rate of the screen to the second refresh rate determined by the refresh rate determination sub-module 431.

In one exemplary embodiment, the refresh rate determination sub-module 431 is further configured to: search a first correspondence for a backlight current corresponding to the backlight intensity, the first correspondence used to record a relationship between different backlight intensities and different backlight currents; and search a second correspondence for the second refresh rate corresponding to the backlight current, the second correspondence used to record a relationship between different backlight currents and different second refresh rates.

In one exemplary embodiment, the refresh rate adjustment sub-module 432 is further configured to: determine a first transmission rate based on the second refresh rate and adjust a current second transmission rate to the first transmission rate. The second transmission rate corresponds to the first refresh rate. The first transmission rate is a data transmission rate of the static image and is lower than the second transmission rate.

In some embodiments, the refresh rate adjustment sub-module 432 may be further configured to transmit data with the current second transmission rate. The data includes at least two sets of valid data between which at least one set of invalid data is inserted. The valid data is data of the static image, and the invalid data is not displayed in the screen.

In one exemplary embodiment, the device 400 may further include: a refresh rate determination module 440 and a second adjustment module 450.

The refresh rate determination module 440 is configured to determine the first refresh rate corresponding to the static image based on the dynamic frame rate technology when the image currently displayed on the screen is the static image.

The second adjustment module 450 is configured to reduce a current fourth refresh rate of the screen to the first refresh rate determined by the refresh rate determination module 440.

In one exemplary embodiment, the device 400 may further include a third adjustment module 460.

The third adjustment module 460 is configured to increase the second refresh rate to the fourth refresh rate when the image currently displayed on the screen is changed.

The device 400 may solve the problem that the screen has a higher power consumption due to a higher refresh rate set according to the dynamic frame rate technology when the screen displays a static image, thereby achieving the effect of saving power consumption. In addition, due to the backlight intensity being related with a dimming speed of the screen, the second refresh rate determined based on the backlight intensity may not cause the screen to flicker, which may solve the problem of screen flicker when a same refresh rate is set for the screen with different backlight intensities.

When the image currently displayed by the terminal is changed, by increasing the second refresh rate to the fourth refresh rate, the device 440 may further solve the following problem and improve the display effect of the screen: the screen may not display a complete image when a refresh rate is used to display a varying image and the refresh rate is lower than the change rate of the varying image.

The present disclosure provides a device for adjusting a refresh rate, which implements the above described methods. The device may include: a processor; a screen coupled to the processor, and a memory for storing instructions executable by the processor. The processor is configured to: detect whether an image currently displayed on a screen is a static image which remains unchanged for a predetermined period of time; obtain a backlight intensity of the screen when the image currently displayed on the screen is the static image; and reduce a current first refresh rate of the screen to a second refresh rate based on the backlight intensity. The second refresh rate is lower than a third refresh rate obtained by adjusting the refresh rate of the screen based on dynamic frame rate technology.

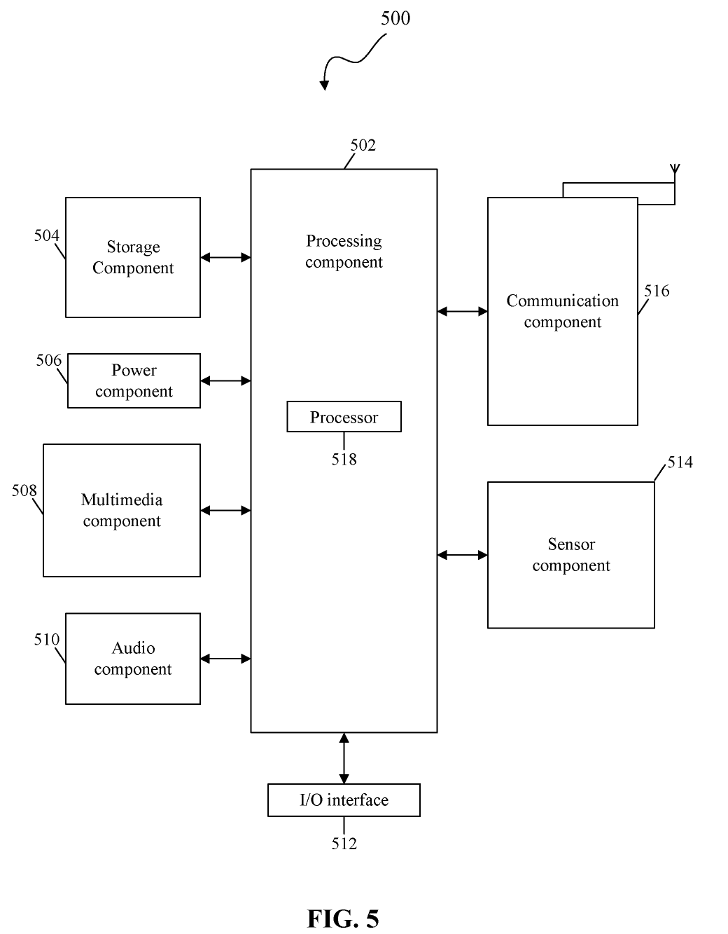

FIG. 5 is a block diagram of a device 500 according to an exemplary embodiment. For example, the device 500 may be a mobile phone, a computer, a digital broadcast terminal, a message transceiver, a game console, a tablet device, a medical equipment, a fitness equipment, a personal digital assistant, and the like.

Referring to FIG. 5, the device 500 may include one or more of the following components: a processing component 502, a storage component 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 518 to execute instructions to perform all or part of the steps in the above described methods. Moreover, the processing component 502 may include one or more modules which facilitate the interaction between the processing component 502 and other components. For instance, the processing component 502 may include a multimedia module to facilitate the interaction between the multimedia component 508 and the processing component 502.

The storage component 504 is configured to store various types of data to support the operation of the device 500. Examples of such data may include instructions for any applications or methods operated on the device 500, contact data, phonebook data, messages, pictures, video, etc. The storage component 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also detect a period of time and a pressure associated with the touch or swipe action. In some embodiments, the multimedia component 508 includes a front camera and/or a rear camera. The front camera and/or the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the device 500 is in an operation mode, such as a call mode, a recording mode, and a voice recognition mode. The received audio signal may be further stored in the storage component 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500.

The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a distance sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, 3G, or 4G, or a combination thereof. In one exemplary embodiment, the communication component 516 receives a broadcast signal from an external broadcast management system via a broadcast channel or broadcast associated information. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 504 and executable by the processor 518 in the device 500, to perform the above-described methods. For example, the non-transitory computer-readable storage medium may be a ROM, a RAM, a CD-ROM, a magnetic tape, a floppy disc, an optical data storage device, and the like.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and embodiments are merely considered to be exemplary and the substantive scope and spirit of the disclosure is limited only by the appended claims.

It should be understood that the disclosure is not limited to the precise structure as described above and shown in the figures, but can have various modification and alternations without departing from the scope of the disclosure. The scope of the disclosure is limited only by the appended claims.

What is claimed is:

1. A method for adjusting a refresh rate for a screen of a device, comprising:
detecting whether an image currently displayed on the screen is a static image, the static image being an image that remains unchanged for a predetermined period of time;
obtaining a backlight intensity of the screen when the image currently displayed on the screen is the static image; and
reducing a current first refresh rate of the screen to a second refresh rate based on the backlight intensity, the second refresh rate being lower than a third refresh rate obtained based on a dynamic frame rate technology.

2. The method of claim 1, wherein reducing the current first refresh rate of the screen to the second refresh rate based on the backlight intensity comprises:
determining the second refresh rate corresponding to the backlight intensity, wherein the second refresh rate is positively correlated with the backlight intensity; and
reducing the current first refresh rate of the screen to the second refresh rate.

3. The method of claim 2, wherein determining the second refresh rate corresponding to the backlight intensity comprises:
searching a first correspondence for a backlight current corresponding to the backlight intensity, the first correspondence used to record a relationship between different backlight intensities and different backlight currents; and
searching a second correspondence for the second refresh rate corresponding to the backlight current, the second correspondence used to record a relationship between different backlight currents and different second refresh rates.

4. The method of claim 2, wherein reducing the current first refresh rate of the screen to the second refresh rate comprises at least one of:
determining a first transmission rate based on the second refresh rate and adjusting a current second transmission rate to the first transmission rate, wherein the first transmission rate is a data transmission rate of the static image and is lower than the second transmission rate; or
transmitting data with the current second transmission rate, wherein the data comprises at least two sets of valid data between which at least one set of invalid data is inserted, the valid data is data of the static image, and the invalid data is not displayed on the screen;
wherein the second transmission rate corresponds to the first refresh rate.

5. The method of claim 1, wherein when the third refresh rate is the first refresh rate, the method further comprises:
determining the first refresh rate corresponding to the static image based on the dynamic frame rate technology when the image currently displayed on the screen is the static image; and
reducing a current fourth refresh rate of the screen to the first refresh rate.

6. The method of claim 5, comprising:
increasing the second refresh rate to the fourth refresh rate when the image currently displayed on the screen is changed.

7. A device, comprising:
a processor;
a screen coupled to the processor; and
a memory for storing instructions executable by the processor;
wherein the processor is configured to:
detect whether an image currently displayed on the screen is a static image, the static image being an image that remains unchanged for a predetermined period of time;
obtain a backlight intensity of the screen when the image currently displayed on the screen is the static image; and
reduce a current first refresh rate of the screen to a second refresh rate based on the backlight intensity, the second refresh rate being lower than a third refresh rate obtained based on a dynamic frame rate technology.

8. The device of the claim 7, wherein the processor is further configured to:
determine the second refresh rate corresponding to the backlight intensity, wherein the second refresh rate is positively correlated with the backlight intensity; and
reduce the current first refresh rate of the screen to the second refresh rate.

9. The method of claim 8, wherein the processor is further configured to:
search a first correspondence for a backlight current corresponding to the backlight intensity, the first correspondence used to record a relationship between different backlight intensities and different backlight currents; and
search a second correspondence for the second refresh rate corresponding to the backlight current, the second correspondence used to record a relationship between different backlight currents and different second refresh rates.

10. The device of claim 8, wherein the processor is further configured to perform at least one of:
determining a first transmission rate based on the second refresh rate and adjusting a current second transmission rate to the first transmission rate, wherein the first transmission rate is a data transmission rate of the static image and is lower than the second transmission rate; or
transmitting data with the current second transmission rate, wherein the data includes at least two sets of valid data between which at least one set of invalid data is inserted, the valid data is data of the static image, and the invalid data is not displayed on the screen;
wherein the second transmission rate corresponds to the first refresh rate.

11. The device of claim 7, wherein when the third refresh rate is the first refresh rate, the processor is further configured to:
determine the first refresh rate corresponding to the static image based on the dynamic frame rate technology when the image currently displayed on the screen is the static image; and
reduce a current fourth refresh rate of the screen to the first refresh rate.

12. The device of claim 11, wherein the processor is further configured to:
increase the second refresh rate to the fourth refresh rate when the image currently displayed on the screen is changed.

13. A non-transitory computer-readable storage medium having stored therein instructions that, when executed by a processor of a device, cause the device to perform a method for adjusting a refresh rate, the method comprising:
detecting whether an image currently displayed on a screen of the device is a static image, the static image being an image that remains unchanged for a predetermined period of time;
obtaining a backlight intensity of the screen when the image currently displayed on the screen is the static image; and
reducing a current first refresh rate of the screen to a second refresh rate based on the backlight intensity, the second refresh rate being lower than a third refresh rate obtained based on dynamic frame rate technology.
